(19) United States
(12) Patent Application Publication
(10) Pub. No.: US 2010/0245174 A1
(43) Pub. Date: Sep. 30, 2010

(54) POSITIONING DEVICE AND PROGRAM RECORDING STORAGE MEDIUM FOR POSITIONING

(75) Inventors: Kyouko Okuyama, Kawasaki (JP); Kensuke Sawada, Kawasaki (JP); Shinichiro Mori, Kawasaki (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, KAWASAKI-SHI (JP)

(21) Appl. No.: 12/730,221

(22) Filed: Mar. 23, 2010

(30) Foreign Application Priority Data
Mar. 24, 2009 (JP) 2009-72603

(51) Int. Cl. G01S 3/02

(52) U.S. Cl. 342/451; 342/450; 342/458

(57) ABSTRACT

A positioning device includes: a device body; a direction change detecting section that detects whether a traveling direction of the device body has been changed based on a detection of an azimuth with respect to reference axes preset in the device body; and an absolute position acquiring section that acquires an absolute position of the device body at a timing based on a change of the moving direction of the device body as detected by the direction change detecting section.

### CROSS-REFERENCE TO RELATED APPLICATIONS

This application is based upon and claims the benefit of priority of the prior Japanese Patent Application No. 2009-72603, filed on Mar. 24, 2009, the entire contents of which are incorporated herein by reference.

### FIELD

The embodiments discussed herein are related to a positioning device and a program recording storage medium for positioning.

### BACKGROUND

Japanese Laid-open Patent Publication No. 11-194033 discusses about a portable terminal (a mobile terminal) including a device for calculating a moving route (a walking route) of a user using a self-contained navigation system.

The device of the above mentioned type includes, for example, an azimuth detecting function of detecting an azimuth, a step number detection function of detecting the number of steps, a moving distance calculating function of calculating a moving distance from the product of a stride which has been input in advance and the number of steps and a position detecting function of acquiring an absolute position of a current position which is similar to that of a GPS (Global Positioning System) receiver and calculates the moving route of the user on the basis of values (of the absolute position, the azimuth and the moving distance) acquired using these functions.

Calculation of the moving route using the self-contained navigation system as mentioned above allows to reduce the number of measuring operations performed using the GPS receiver as compared with moving route calculation performed using the GPS receiver alone and hence allows to reduce the consumption power.

However, the number of steps detected using the step number detecting function and the value measured using the GPS function include errors. Thus, in the case that the device is oriented in a direction different from its traveling direction, errors occur in azimuth. Therefore, in the case that the self-contained navigation system is used, it may become necessary to correct these errors.

In the case that a magnetic sensor is used as a device that functions to detect an azimuth, it may be necessary to execute calibration on the magnetic sensor. For example, in the case of magnetic sensors mounted on a mobile terminal such as a mobile phone, these sensors are disposed at two or three positions and measure the earth magnetism to measure the azimuth at their respective positions. In the magnetic sensor as mentioned above, such a problem may occur that when one of components disposed around the sensor is polarized, a deviation (offset) is induced in an output from the magnetic sensor, influenced by a magnetic field that leaks from the polarized component and hence an error occurs in azimuth detection due to the offset of the output from the magnetic sensor. It is known to be effective to turn the mobile terminal (waving it in the form of 8) in order to calibrate the offset. The more the number of turning operations is increased (the more frequently the mobile terminal is turned), the more accurately the calibration is performed. For example, International Publication Pamphlet No. WO2004/003476 discusses about a technique coping with the above problem.

### SUMMARY

According to an aspect of an embodiment, a positioning device includes: a device body; a direction change detecting section that detects whether a traveling direction of the device body has been changed based on a detection of an azimuth with respect to reference axes preset in the device body; and an absolute position acquiring section that acquires an absolute position of the device body at a timing based on a change of the moving direction of the device body as detected by the direction change detecting section. It is to be understood that both the foregoing summary description and the following detailed description are exemplary and explanatory and are not restrictive of the invention, as claimed.

### BRIEF DESCRIPTION OF THE DRAWINGS

FIG. 1 is a block diagram illustrating a configuration of a mobile phone according to an example of a first embodiment;

FIG. 2A is one flowchart illustrating a moving route acquiring process executed using the mobile phone illustrated in FIG. 1;

FIG. 2B is another flowchart illustrating the moving route acquiring process executed using the mobile phone illustrated in FIG. 1;

FIG. 3A is a diagram illustrating a relation between a relative moving route and absolute positions to be acquired;

FIG. 3B is a diagram illustrating procedures of acquiring the relative moving route;

FIG. 3C is a diagram illustrating an example of a database prepared when the relative moving route is acquired;

FIG. 4 is a diagram illustrating a method of calculating a direction change angle α from absolute positions a, b and c;

FIGS. 5A and 5B are diagrams illustrating a method of correcting the angle of the relative moving route with the direction change angle α;

FIG. 6 is a diagram illustrating a process at S40 in FIG. 2B;

FIGS. 7A and 7B are diagrams illustrating a process at S42 in FIG. 2B;

FIGS. 8A and 8B are diagrams illustrating a process at S44 in FIG. 2B;

FIGS. 9A and 9B are diagrams illustrating an altered example of the first embodiment;

FIG. 10 is a flowchart relating to processes executed in the altered example of the first embodiment;

FIG. 11 is a flowchart illustrating details of processes at S17 and S23 in FIG. 10;

FIG. 12 is a diagram illustrating details of the processes in FIG. 11;

FIG. 13 is a diagram illustrating another example of the first embodiment;

FIG. 14 is a flowchart illustrating a relative moving route correcting process according to an example of a second embodiment;

FIG. 15 is a diagram illustrating the process in FIG. 14; and

FIGS. 16A and 16B are flowchart illustrating a relative moving route correcting process according to an example of a third embodiment.

### DESCRIPTION OF EMBODIMENTS

Even though an offset in output from a magnetic sensor is successfully calibrated using the above mentioned related art, an error in azimuth on the order of ±1° to 5° may still remain. In addition, in the case that calibration has not been successfully performed, an error in azimuth exceeding 30° may remain. Moreover, in the case that a moving route of a positioning device is detected on the basis of the output from the magnetic sensor, if the error in azimuth remains, displacement of the moving route may be increased (increased up to two times the error in azimuth) when a traveling direction of the positioning device has been changed (for example, when a user has turned a corner).

### First Embodiment

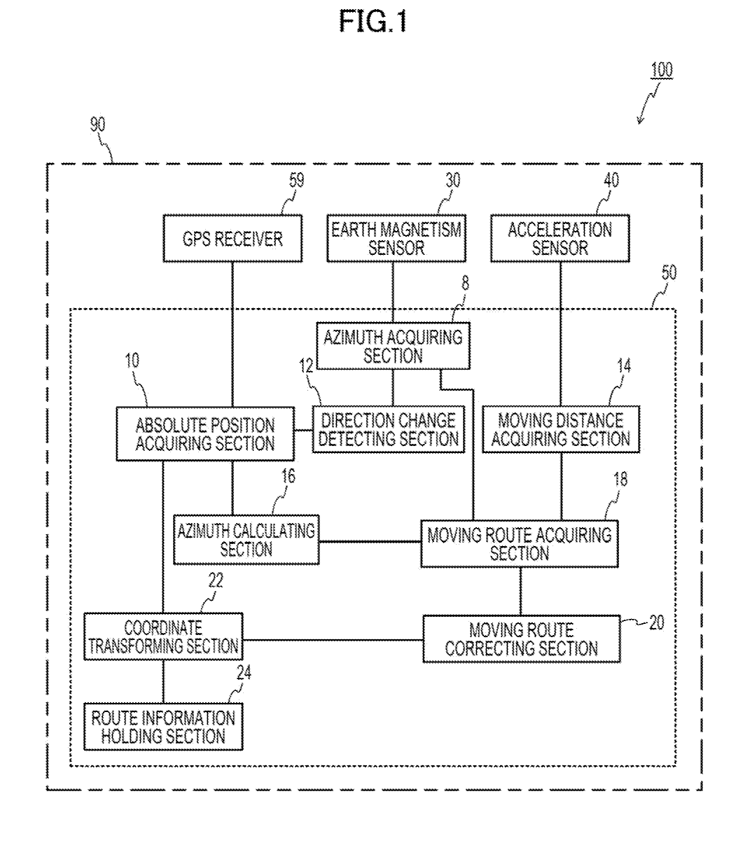

Next, a first embodiment will be described in detail with reference to FIGS. 1 to 8.

FIG. 1 is a block diagram illustrating a configuration of a mobile phone 100 as a positioning device or having positioning capability. As illustrated in FIG. 1, the mobile phone 100 includes a mobile phone body 90 as a device main body, and an earth magnetism sensor 30, an acceleration sensor 40, a GPS receiver 59 and a moving route specifying device 50 which are installed in the mobile phone body 90. Incidentally, the mobile phone 100 has a talking function and, in some cases, has other various functions such as communicating functions of transmitting/receiving e-mails and performing data communication via Internet and photographing and image capturing functions. However, in FIG. 1, for the simplicity of explanation, illustration of a configuration used to realize these functions is omitted.

The earth magnetism sensor 30 is a magnetic azimuth sensor that realizes detection of earth magnetism, for example, on a three-axis coordinate system. The acceleration sensor 40 is a sensor that detects, for example, tri-axial acceleration. The GPS receiver 59 receives signals from a plurality of GPS satellites which are stationary high up in the sky to obtain information on absolute positions (positions indicated in latitude and longitude) of the mobile phone.

The moving route specifying device 50 includes an azimuth acquiring section 8, an absolute position acquiring section 10, a direction change detecting section 12, a moving distance acquiring section 14, an azimuth calculating section 16, a moving route acquiring section 18, a moving route correcting section 20, a coordinate transforming section 22 and a route information holding section 24.

The azimuth acquiring section 8 acquires a value of earth magnetism detected using the earth magnetism sensor 30 to acquire an azimuth (hereinafter, referred to as a relative azimuth) with respect to preset reference axes, namely, to acquire an azimuth pointed at with axes which have been set in advance (that is, an azimuth with respect to preset reference axes) in the mobile phone body 90 on the basis of the acquired earth magnetism value. The absolute position acquiring section 10 acquires absolute positions via the GPS receiver 59. The direction change detecting section 12 detects information as to whether a user of the mobile phone 100 has changed his traveling direction, for example, by turning a corner (information as to whether the user is moving without changing his traveling azimuth) on the basis of the relative azimuth acquired using the azimuth acquiring section 8.

The moving distance acquiring section 14 holds in advance stride information indicative of the length of one step of the user input by the user and calculates the moving distance (=stride×step number) of the user from the stride information and information on the number of steps which is calculated from the acceleration detected using the acceleration sensor 40. Incidentally, the way of obtaining the step number itself is the same as that of a pedometer using a general acceleration sensor. The azimuth calculating section 16 calculates an angle at which the user who carries the mobile phone 100 has changed his traveling direction (hereinafter, referred to as a direction change angle) on the basis of the absolute positions acquired using the absolute position acquiring section 10. A method of calculating the direction change angle will be described later.

Moving routing acquiring section 18 calculates a relative moving route from the relative azimuth acquired using the azimuth acquiring section 8 and the moving distance of the user calculated using the moving distance acquiring section 14. And moving routing acquiring section 18 corrects the relative moving route on the basis of the direction change angle calculated using the azimuth calculating section 16. Hereinafter, the relative moving route obtained after correction will be referred to as the “corrected moving route”. Details of a process of acquiring the moving route will be also described later.

The moving route correcting section 20 further corrects the corrected moving route using the absolute positions acquired using the absolute position acquiring section 10. The coordinate transforming section 22 transforms the coordinates of the relative moving route corrected using the moving route correcting section 20 into absolute coordinates. The route information holding section 24 holds (stores) therein a result of transformation performed using the coordinate transforming section 22.

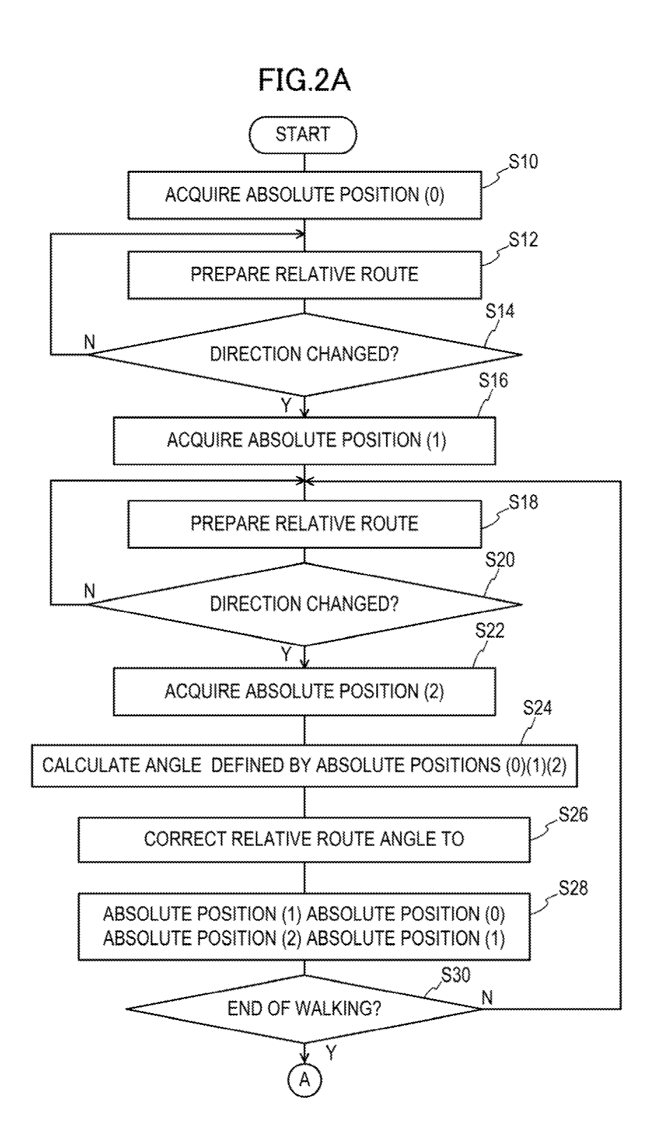

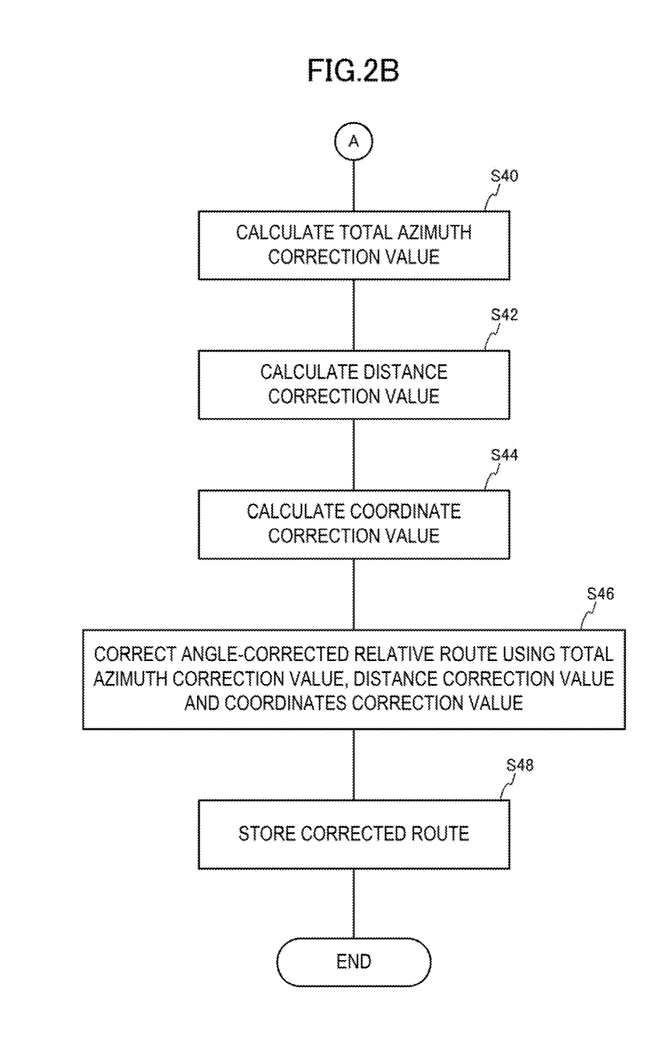

Next, the moving route acquiring process according to the first embodiment will be described in detail along flowcharts illustrated in FIGS. 2A and 2B, while appropriately referring to other drawings.

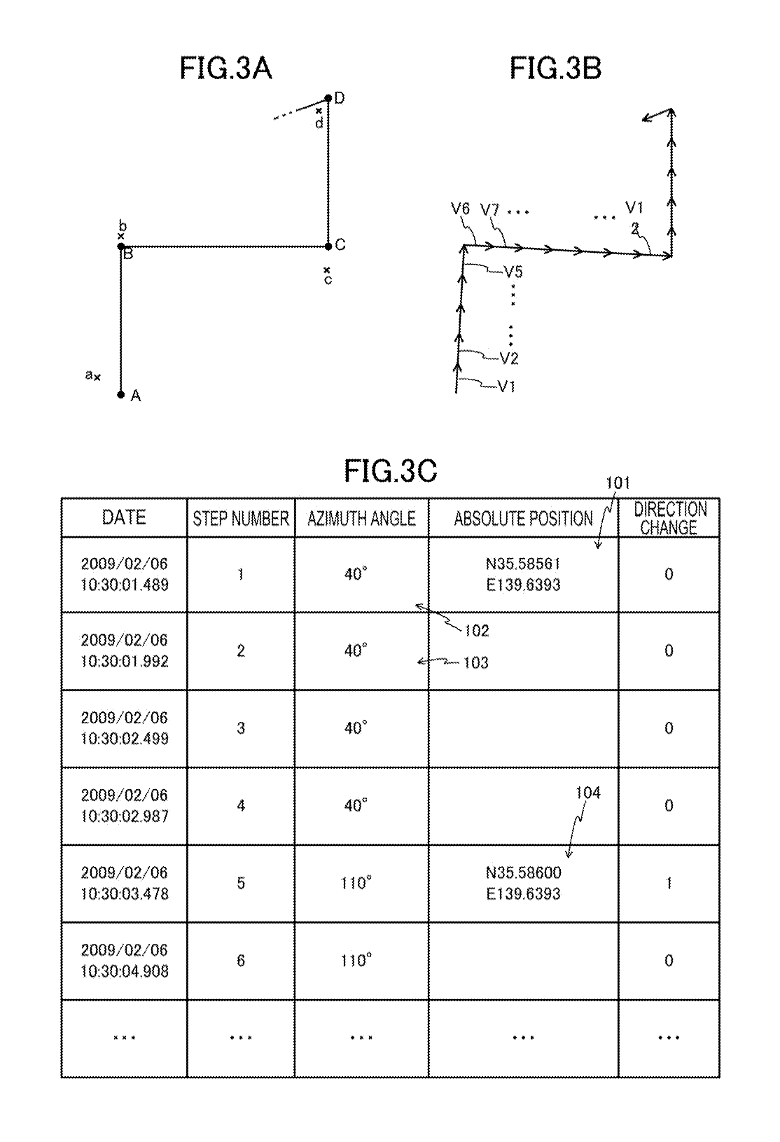

The flowchart in FIG. 2A is started at a moment that the user has input an instruction to start moving route acquisition into the mobile phone 100 and then the acceleration sensor 40 has detected that the user starts walking. Incidentally, while processes are being executed along the flowchart in FIG. 2A, a database of acquired data as illustrated in FIG. 3C is prepared. The database in FIG. 3C is prepared every time the user takes one step forward and includes the date, the number of steps counted from the moment that the user has started walking, the azimuth angle (the relative azimuth) acquired using the azimuth acquiring section 8, the absolute position acquired using the absolute position acquiring section 10 and the identifier (0 or 1) indicating whether the user has changed his traveling direction.

First at S10 in FIG. 2A, the absolute position acquiring section 10 acquires an absolute position. In the example illustrated in the drawing, for the convenience of explanation, the absolute position will be referred as the “absolute position (0).” In the above mentioned case, the absolute position acquiring section 10 acquires an absolute position (a position marked with “a”) detected using the GPS receiver 59 at a start-walking point A illustrated in FIG. 3A. A result of acquisition is stored in a column designated by 101 in FIG. 3C.

Then, at S12, the moving route acquiring section 18 calculates a relative moving route V1 illustrated by an arrow in FIG. 3B on the basis of the moving distance calculated using the moving distance acquiring section 14 and the relative azimuth acquired using the azimuth acquiring section 8. Then, at S14, the direction change detecting section 12 judges whether the user (the mobile phone 100) has changed his (its) traveling direction. At this stage, the user takes just one step forward, so that judgment is denied and the process returns to S12.

At S12, the moving route acquiring section 18 calculates a relative moving route V2 illustrated in FIG. 3B in substantially the same manner as the above. At S14, the direction change detecting section 12 judges whether the user (the mobile phone 100) has changed the traveling direction. At S14, the direction change detecting section 12 refers to a change amount of the relative azimuth (the azimuth angle) acquired using the azimuth acquiring section 8 and judges that the traveling direction has been changed in the case that the change amount exceeds a predetermined threshold value (here, it is assumed to be, for example, 50°). Incidentally, in the example illustrated in FIG. 3C, the difference (the change amount) between the angle in a column designated by 102 and the azimuth angle in a column designated by 103 is 0° (=40°−40°, the judgment is also denied.

Then, the processes at S12 and S14 are repeatedly executed until the judgment at S14 is affirmed. Then, as illustrated in FIG. 3C, at a moment that the user has taken the fifth step forward (hereinafter, referred to as a fifth-step moment), the difference (the change amount) between the azimuth angle obtained at that time and the azimuth angle obtained at a fourth-step moment is 70° (=110°−40°, so that the judgment at S14 is affirmed and the process proceeds to S16. The fifth-step moment indicates a moment that the user has reached a position B illustrated in FIG. 3A. The direction change detecting section 12 records the identifier “1” in the corresponding column for direction change in the database illustrated in FIG. 3C at a moment that the traveling direction has been changed as described above. The direction change detecting section 12 automatically records the identifier “0” in each column in which the identifier “1” is not recorded.

At S16, the absolute position acquiring section 10 acquires a fresh absolute position. For the convenience of explanation, the fresh absolute position will be referred as an “absolute position (1).” In the above mentioned case, the absolute position acquiring section 10 acquires an absolute position (designated by b) detected using the GPS receiver 59 at the position B where the traveling direction has been changed (the position of the first corner). A result of acquisition is stored in a column designated by 104 in FIG. 3C.

Then, a process at S18 and judgment at S20 are repeatedly executed in substantially the same manner as those at S12 and S14 to calculate relative moving routes (routes V6, V7 and so on) illustrated by arrows in FIG. 3B.

In the case that the judgment at S20 has been affirmed, the absolute position acquiring section 10 acquires a fresh absolute position at S22. For the convenience of explanation, the fresh absolute position will be referred as an “absolute position (2).” In the above mentioned case, the absolute position acquiring section 10 acquires an absolute position (designated by c) detected using the GPS receiver 59 at a direction changed position (the position of the second corner) C. A result of acquisition is stored in the database in FIG. 3C.

Then, at S24, the azimuth calculating section 16 calculates an angle (a direction change angle)α of a straight line a-b coupling together the positions a and b relative to a straight line b-c coupling together the positions b and c using the absolute positions (0), (1) and (2) respectively acquired at S10, S16 and S22.

Incidentally, assuming that the coordinates of the position a is (x0, y0), the coordinates of the position b is (x1, y1) and the coordinates of the position c is (x2, y2), the vector between the positions a and b will be expressed as (x0-x1, y0-y1) and the vector between the positions b and c will be expressed as (x2-x1, y2-y1). Thus, a cosine (cos(α)) of the angle α between the both vectors may be expressed by the following equation (1). It may be also possible to derive the direction change angle α from the value of cos(α). Incidentally, the respective coordinates of the absolute positions a, b and c are coordinates which have been transformed on the coordinate system of the relative position.

$$\begin{matrix}[ Numerical Formula 1 ] & \\ cos ( α ) = \frac{( x 0 - x 1 ) \times ( x 2 - x 1 ) + ( y 0 - y 1 ) \times ( y 2 - y 1 )}{\sqrt{{( x 0 - x 1 )}^{2} + {( y 0 - y 1 )}^{2}} \sqrt{{( x 2 - x 1 )}^{2} + {( y 2 - y 1 )}^{2}}} & ( 1 )\end{matrix}$$

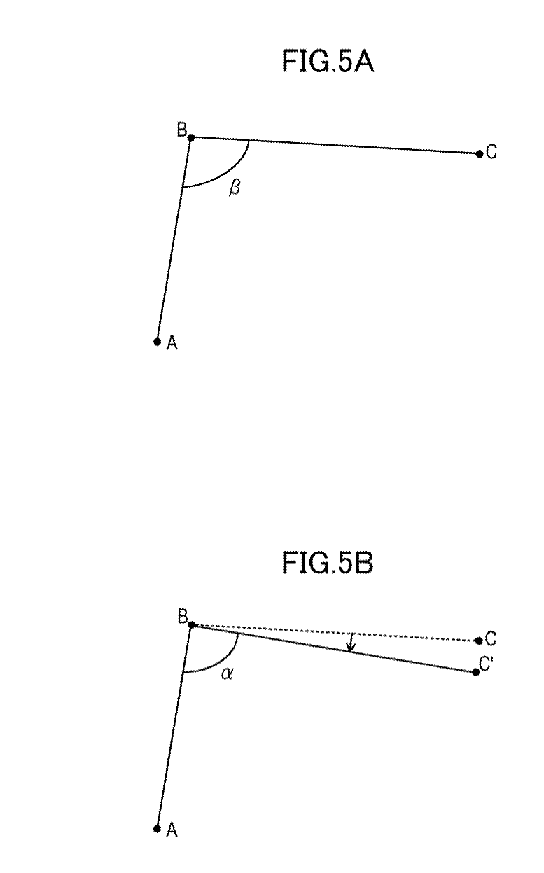

At S26, the moving route acquiring section 18 corrects the angle (the angle of the corner) obtained when the traveling direction has been changed along relative routes (routes V1 to V12) to the direction change angle α. That is, in the case that the relative routes have been acquired in the form of a route as illustrated in FIG. 5A, an angle β obtained upon direction change is corrected to the angle α as illustrated in FIG. 5B. In the example illustrated in the drawing, although the angle α is present on each side of the straight line A-B as a reference, the angle α which is smaller in correction amount by which it is corrected from the angle β is assumed to be adopted. As a result of this correction, the point C will be corrected to a point C′.

Then, at S28 in FIG. 2A, the moving route acquiring section 18 replaces the absolute position (1) with the absolute position (0) and the absolute position (2) with the absolute position (1). Then, at S30, the moving distance acquiring section 14 judges whether the user has finished walking from a result of detection executed using the acceleration sensor 40. In the case that judgment has been affirmed, the process proceeds to S40 in FIG. 2B. On the other hand, in the case that the judgment has been denied, the process returns to S18.

In the case that the process has returned to S18, a relative route extending up to the next direction change position D is prepared (S18) as illustrated in FIG. 3A and the absolute position (2) (a position designated by d) is acquired at the direction change position D (S22). Then, an angle (a direction change angle) α′between the straight lines b-c and c-d is calculated (S24) and the angle obtained upon direction change along the relative route is corrected to the angle α′(S26).

Then, the processes at S18 to S28 are repeatedly executed to repeatedly correct the absolute route in accordance with the calculated direction change angle until judgment at S30 is affirmed. Then, at a moment that the judgment at S30 has been affirmed, the process proceeds to S40 in FIG. 2B.

At S40 in FIG. 2B, the moving route correcting section 20 executes a process of calculating a total azimuth correction value. In the following, for the simplicity of explanation, description will be made on the assumption that the user has finished walking when he has moved from the position a to the position c.

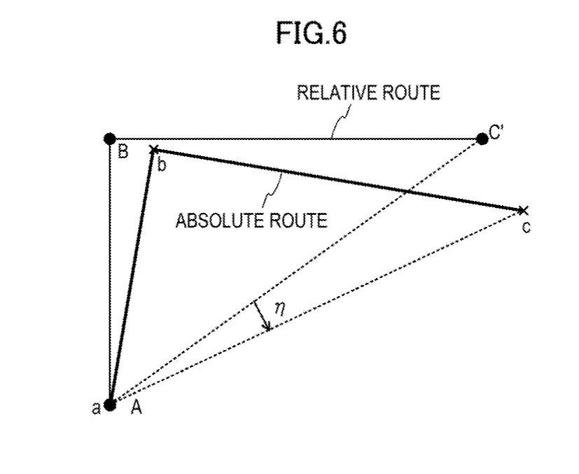

In the total azimuth correction value calculating process, the moving route correcting section 20 selects two positions which are the most separated from each other from three absolute positions (position values measured using the GPS receiver (hereinafter, referred to as GPS-measured position values)) and selects two points on a relative route corresponding to the most separated two absolute positions. In the example, the points a and c and their corresponding points A and C′ illustrated in FIG. 6 are respectively selected.

Next, the moving route correcting section 20 calculates a rotation angle η with which an azimuth angle between two points (the points A and C) on the relative route is made coincide with an azimuth angle between two points (the points a and c) on the absolute route. In this embodiment, the rotation angle η is set as the total azimuth correction value.

Highly accurate and ready calculation of the total azimuth correction value may become possible by calculating the total azimuth correction value (η) as mentioned above. Although, in the case that a position measurement error is present in the GPS-measured position value, it may be desirous to calculate the total azimuth correction value considering the position measurement error, description on this point will be omitted.

Returning to the flowchart illustrated in FIG. 2B, at S42, the moving route correcting section 20 executes a distance correction value calculating process.

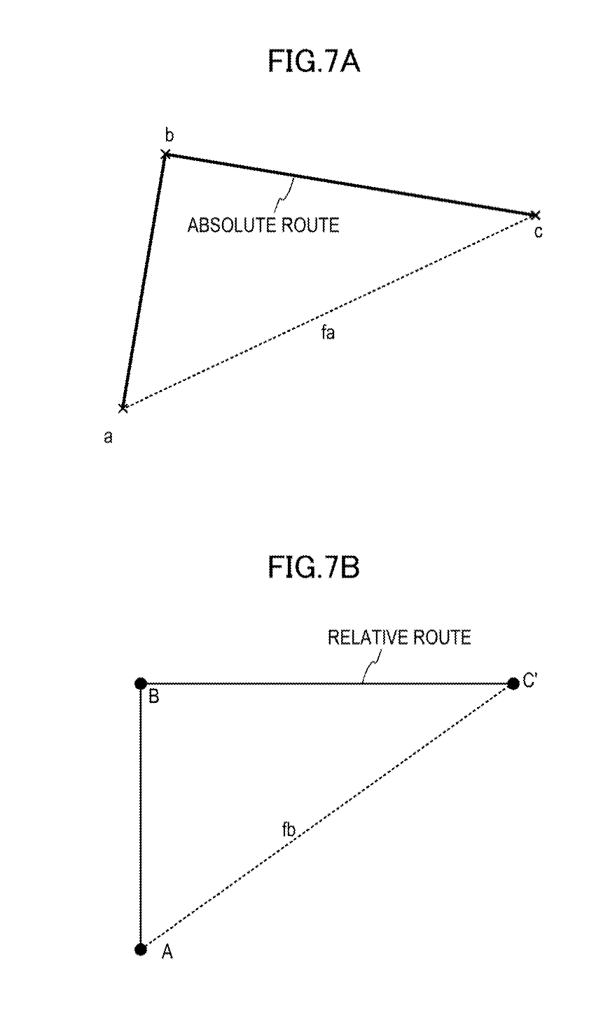

In the distance correction value calculating process, the moving route correcting section 20 calculates a distance (a distance measured using the GPS receiver) fa between the two points a and c on the absolute route as illustrated in FIG. 7A and calculates a distance (a relative route distance) fb between the two points A and C′ on the relative route as illustrated in FIG. 7B. Then, a ratio c of one distance to another distance is calculated on the basis of the following equation (2). In this embodiment, the ratio c is set as the distance correction value.

ε=fa/fb (2)

Ready and highly accurate calculation of the distance correction value may become possible by adopting the distance correction value calculating method as mentioned above. In the case that a position measurement error is present in the GPS-measured position value, it may be desirous to execute the distance correction value calculation considering the position measurement error. However, description on this point will be omitted.

Returning to the flowchart in FIG. 2B, at S44, the moving route correcting section 20 executes a coordinate correction value calculating process.

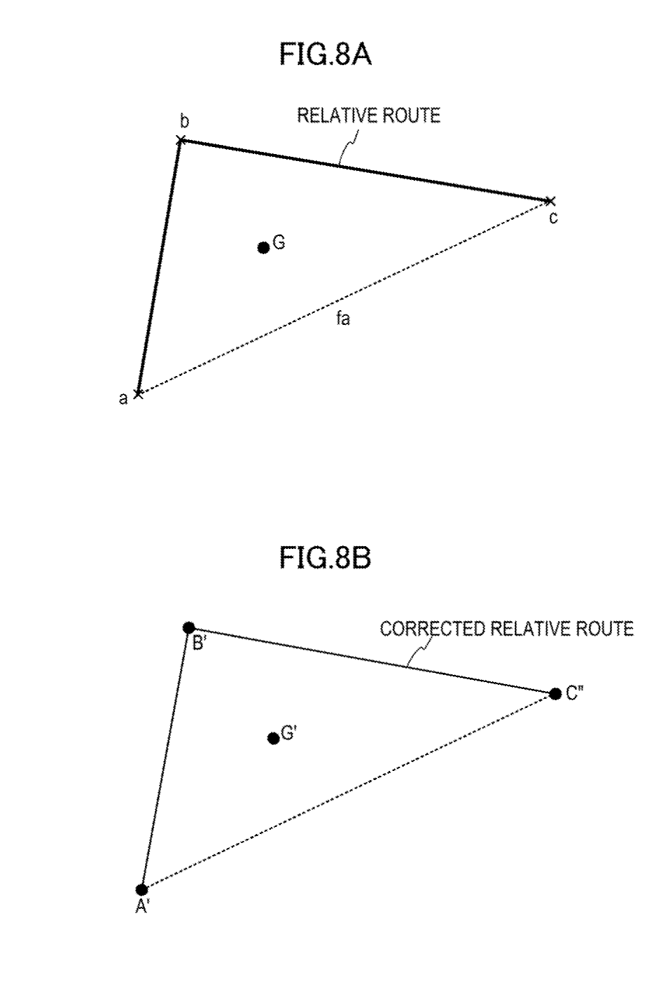

In the coordinate correction value calculating process, the moving route correcting section 20 corrects a relative route ABC' using the total azimuth correction value η and the distance correction value c calculated at S40 and S42 and sets corrected points corresponding to the points A, B and C′ obtained before correction as points A′, B′ and C″ as illustrated in FIG. 8B.

Then, the moving route correcting section 20 calculates the center of gravity G as illustrated in FIG. 8A with respect to three absolute positions (the GPS-measured position values) a, b and c and also calculates the center of gravity G′ as illustrated in FIG. 8B with respect to points A′, B′ and C″ on the corrected relative route. Then, the moving route correcting section 20 calculates a difference Δcx, Δcy in coordinates between the center of gravity G and the center of gravity G′. In this embodiment, the difference Δcx, Δcy is set as the coordinate correction value. Ready and highly accurate calculation of the coordinate correction value may become possible by adopting the coordinate correction value calculating method as mentioned above. In the case that a position measurement error is present in the GPS-measured position value, it may be desirous to execute coordinate correction value calculation considering the position measurement error. However, description on this point will be omitted.

Next, at S46 in FIG. 2B, the moving route correcting section 20 corrects again the relative route ABC' which has been corrected in direction change angle using the total azimuth correction value η, the distance correction value c and the coordinate correction value Δcx, Δcy. The coordinate transforming section 22 transforms the relative route ABC′ which has been again corrected to a route (in latitude and longitude) on the absolute coordinate system.

Then, at S48, the route information holding section 24 stores (holds) the route obtained as a result of execution of the process at S46 and terminates execution of all the processes illustrated in FIGS. 2A and 2B.

As described above, according to the first embodiment, the direction change detecting section 12 detects whether the traveling direction of the user (the mobile phone 100) has been changed on the basis of the result of acquisition executed using the azimuth acquiring section 8. The absolute position acquiring section 10 acquires the absolute position of the mobile phone 100 at the timing (in the example, the direction change timing) determined on the basis of information as to whether the traveling direction has been changed. Then, the moving route acquiring section 18 specifies the moving route of the mobile phone 100 from the absolute position information and the moving distance.

In the case that a measurement error is present in the value obtained using the earth magnetism sensor 30, influenced by the leakage magnetic field or the like, the reliability of a value indicative of the degree (the turning angle) at which the azimuth is changed which is output from the earth magnetism sensor 30 is reduced. However, whether the azimuth has been changed or whether the user has turned to the left or right relative to the traveling direction in which the user has ever moved may be detected still correctly. According to the first embodiment, the traveling direction change angle α may be obtained using the absolute position acquired at the direction change timing obtained from the result of detection executed using the earth magnetism sensor 30. Therefore, highly accurate specification of the moving route may become possible by specifying the moving route using the traveling direction change angle α. That is, since the value indicative of the degree (the turning angle) at which the azimuth is changed which is output from the earth magnetism sensor 30 is not utilized in the specification of the moving route, a reduction in measurement accuracy due to the measurement error in the value obtained using the earth magnetism sensor 30 may be avoided.

In addition, in the first embodiment, the GPS receiver 59 may receive the signals from the GPS satellites at an instance of the direction change timing, so that power saving may be promoted. Specifically, assuming that consecutive position measurement (for example, per second) has been performed using the GPS receiver 59 for a ten-minute walk of the user, about 600 (=10×60) absolute positions will be acquired. On the other hand, according to the first embodiment, if the operation time of the GPS receiver 59 taken for one position measuring operation is about 15 seconds, the consumption power will be more reduced than may be possible by the consecutive position measurement unless the absolute position is measured 40 times for ten minutes. In the above mentioned case, a situation that the absolute position is measured 40 times is limited to such a peculiar situation that measurement upon direction change is executed 39 times except the measurement executed when the user has started walking, that is, a corner appears at intervals of about 20 m at a stride of 80 cm. Therefore, it may become possible for the mobile phone according to the first embodiment to promote power saving more effectively than may be possible by the consecutive position measurement as long as it is normally used.

For example, if an average distance between corners is 50 m, 16 corners will be present over a distance (about 800 m) for a ten-minute walk. In the above mentioned case, the absolute position may be measured 17 times including the measurement executed when the user has started walking. Thus, if the method according to the first embodiment is used, the operation time of the GPS receiver will be reduced to 255 seconds (each operation time (15 seconds)×17 times). This operation time is greatly shorter than the operation time of 600 seconds required for the consecutive position measurement. In addition, the more the average distance between corners is increased, the more the operation time is reduced.

### Altered Example

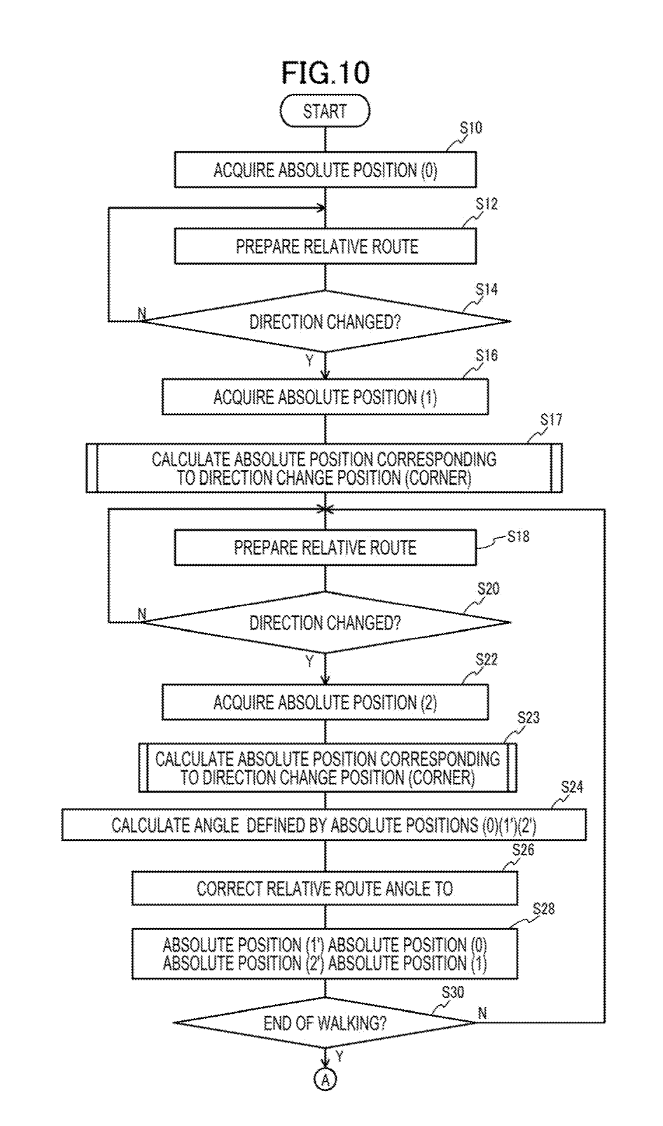

In the above first embodiment, description has been made with respect to the case in which the absolute position (b) is acquired at substantially the same time that the traveling direction has been changed at the point B. However, actually, acquisition of the absolute position may be delayed from the timing that the traveling direction is changed. That is, since the GPS receiver 59 starts operating after direction change has been detected, the signal from the GPS satellite may be received at the position B′ deviating from the direction change position B. In the above mentioned situation, processes in a flowchart illustrated in FIG. 10 are executed instead of the processes in the flowchart illustrated in FIG. 2A.

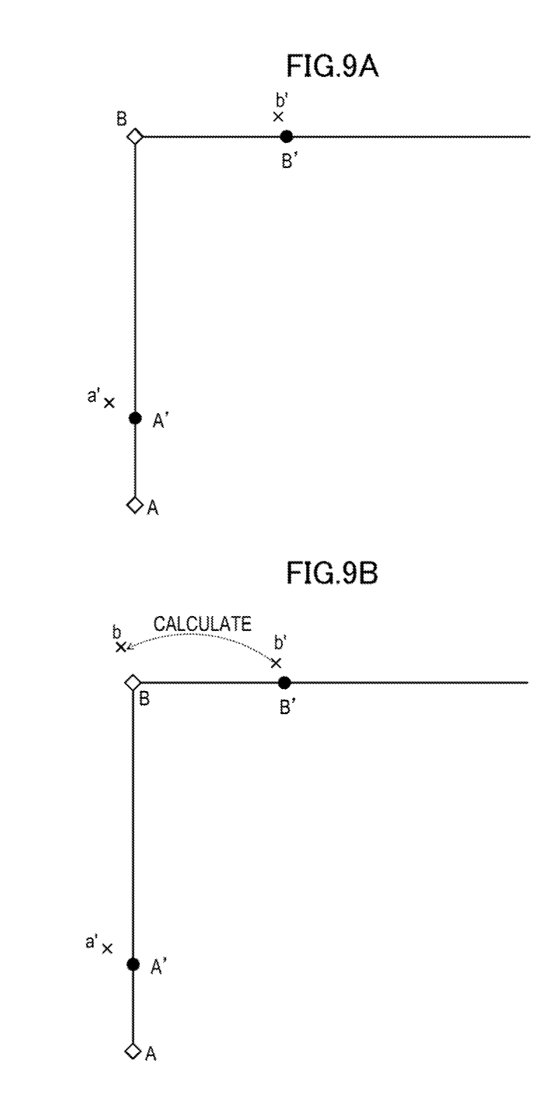

In the processes illustrated in FIG. 10, the processes at S10 to S14 are executed in substantially the same manners as those in the first embodiment such that the absolute position acquiring section 10 acquires the absolute position (0) (a position a′) and the moving route acquiring section 18 prepares the relative route up to a point where the traveling direction is changed. Then, at S16, the absolute position acquiring section 10 acquires the absolute position (1). In the altered example, the absolute position b′ is acquired at the position B′ deviating from the direction change position B as illustrated in FIG. 9A. Although the absolute position a′ is acquired at the position A′ deviating from the position A where the user has started walking also in the acquisition of the absolute position (0) executed at S10, absolute position acquisition at the deviated position may hardly affect the accuracy with which the moving route is specified and hence the absolute position a′ will be used as it is.

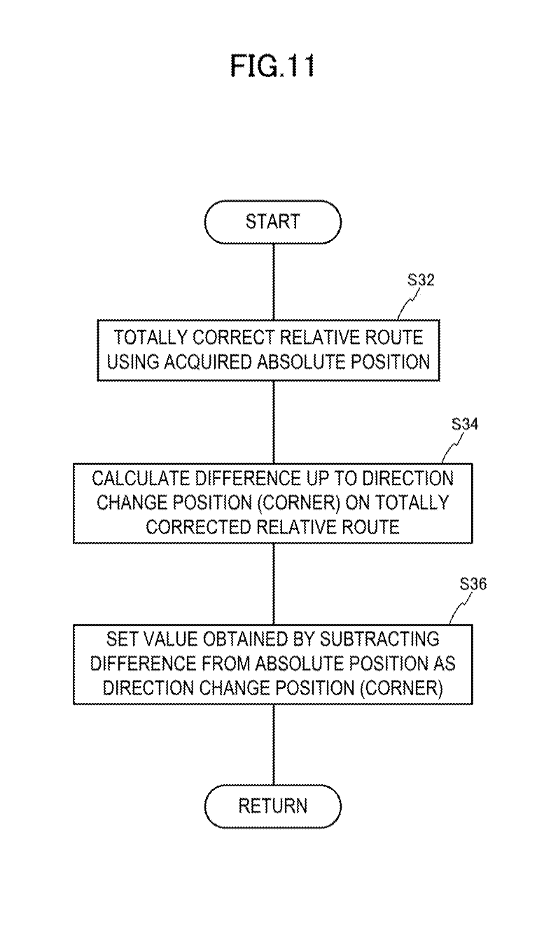

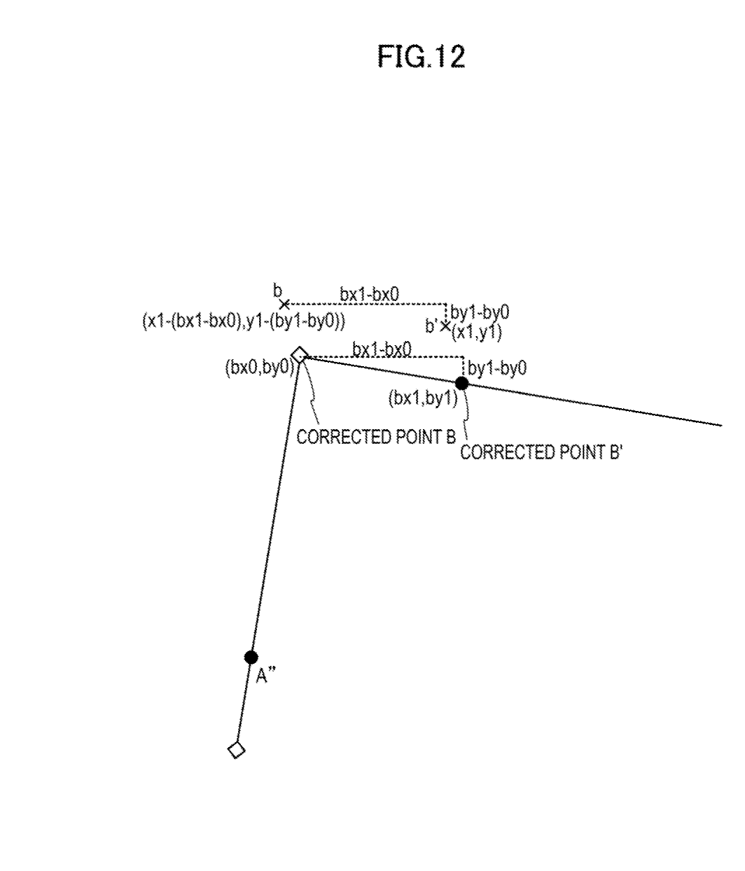

Next, at S17, the absolute position acquiring section 10 calculates an absolute position (the position b) that should have been detected at the direction change position B from the value of the position B′ and the value of the absolute position (1) acquired at the position B′. The process at S17 is executed along the flowchart in FIG. 11.

Specifically, at S32 in FIG. 11, the absolute position acquiring section 10 totally corrects the relative route using the acquired absolute positions a′ and b′. In the above mentioned case, the processes which are substantially the same as those at S40 (calculation of the total azimuth correction value), S42 (calculation of the distance correction value), S44 (calculation of the coordinate correction value) and S46 (correction of the relative route using the respective correction values) in FIG. 2B are executed using the coordinates of two points A′ and B′ on the relative route and two positions a′ and b′ on the absolute route. More specifically, in the process which is substantially the same as that at S40, the angle between straight lines A′-B′ and a′-b′ is set as the total azimuth correction value η. In the process which is substantially the same as that at S42, the ratio of the distance between the points A′ and B′ to the distance between the points a′ and b′ is set as the distance correction value E. In the process which is substantially the same as that at step S44, the difference between the coordinates of the middle point between the points A′ and B′ and the coordinates of the middle point between the points a′ and b′ is set as the coordinate correction value Δcx, Δcy. Then, in the process which is substantially the same as that at S46, the relative route in FIG. 9A is corrected using the respective correction values η, c and Δcx, Δcy.

Then, at S34 in FIG. 11, the absolute position acquiring section 10 calculates a difference in position coordinates between the corrected point B′ and the corrected point B on the relative route which has been totally corrected at step S32. Specifically, assuming that the coordinates of the corrected point B is (b x 0, b y 0) and the coordinates of the corrected point B′ is (b x 1, b y 1), the difference between them will be (b x 1−b x 0, b y 1−b y 0).

Then, at S36, the absolute position acquiring section 10 acquires the coordinates (x 1−(b x 1−b x 0), y 1−(b y 1−b y 0) obtained by subtracting the difference (b x 1−b x 0, b y 1−b y 0) calculated at S34 from the coordinates (x 1, y 1) of the acquired absolute position b′ and sets the acquired coordinates as the coordinates of the absolute position b which should have been detected at the direction change position B. Incidentally, the coordinate system of the absolute position b is substantially the same as that of the relative route.

Then, the process proceeds to S18 in FIG. 10. After the process has proceeded to S18, the processes at S18 to S22 are executed in substantially the same manners as those in the first embodiment. At S23, the absolute position acquiring section 10 acquires the absolute position (2′) which should have been detected at the direction change position C in substantially the same manner as that at S17 (the process in FIG. 11).

Then, at S24, the azimuth calculating section 16 calculates the angle (the direction change angle) αdefined by a route obtained by connecting together the absolute positions (0), (1′) and (2′) from values of these positions using the equation (1). Then, at S26, the moving route acquiring section 18 corrects the angle obtained when the traveling direction has been changed on the relative route to the angle α and, at S28, replaces the absolute position (1′) with the absolute (0) and the absolute position (2′) with the absolute position (1′).

After execution of the above processes, substantially the same processes or operations as those in the first embodiment are executed.

Even in the case that the absolute position acquiring timing is delayed and hence the absolute position cannot be acquired at the direction change position, calculation of the direction change angle and correction of the relative route may be executed with high accuracy by adopting the above mentioned method.

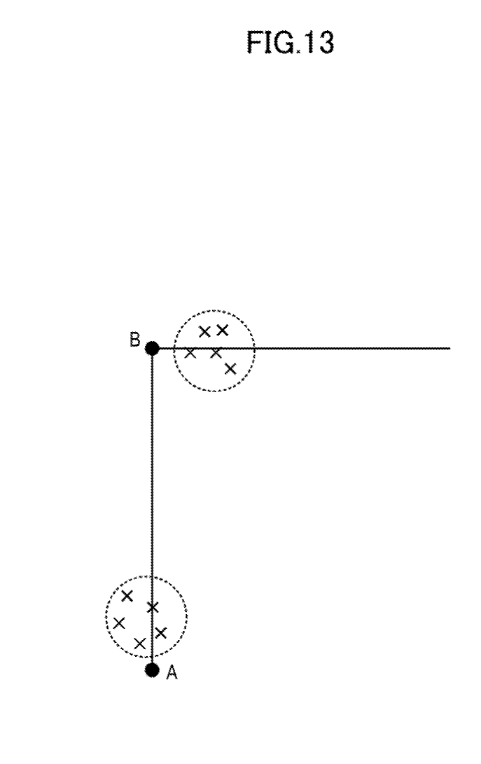

Although in the above first embodiment and its altered example, descriptions have been made with respect to the case in which the coordinates of each one absolute position is acquired at the start-walking position and the direction change position, the embodiment is not limited thereto. For example, in the first embodiment and its altered example, a plurality (two or more) of absolute positions may be acquired in the vicinity of the start-walking position and the direction change position as illustrated in FIG. 13. In the above mentioned case, the absolute positions will be measured while the user is walking. Accordingly, the absolute positions will be measured at positions displacing in a user moving direction. However, to which point on the relative route the position measurement point of each absolute position corresponds has been arranged in the form of the database as illustrated in FIG. 13 so as to be tied with each other upon preparation of the relative route. Therefore, the absolute position corresponding to the start-walking position may be calculated (converted) from the plurality of respective absolute positions acquired in the vicinity of the start-walking position in substantially the same manner as that in the altered example. Likewise, the absolute position corresponding to the direction change position may be calculated (converted) from the plurality of respective absolute positions acquired in the vicinity of the direction change position in substantially the same manner as that in the altered example. In the above mentioned case, more accurate calculation of the direction change angle α may become possible by obtaining the average value of the absolute positions corresponding to the start-walking position and the average value of the absolute positions corresponding to the direction change position and by handling these average values as representative position values of these absolute positions.

### Second Embodiment

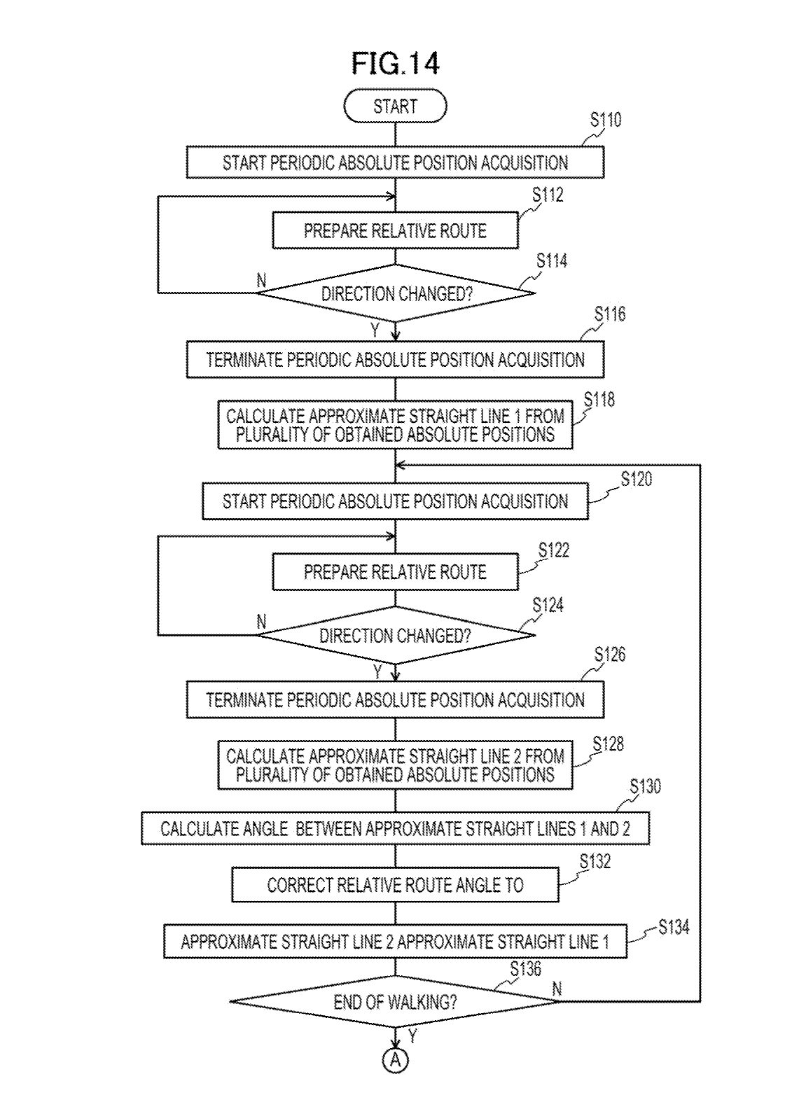

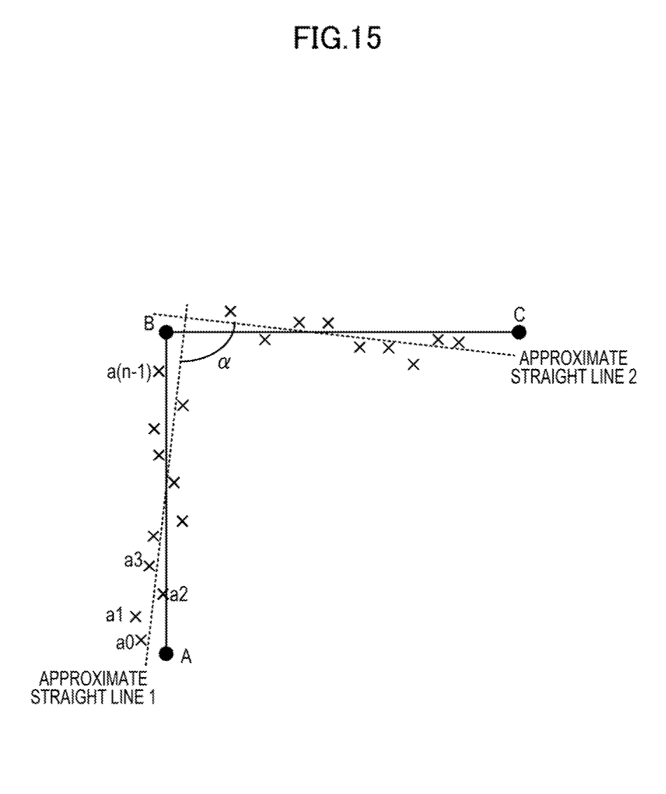

Next, description will be made on a mobile phone as a positioning device or having positioning capability according to a second embodiment with reference to FIGS. 14 and 15. The mobile phone according to the second embodiment has substantially the same configuration as the mobile phone 100 according to the first embodiment illustrated in FIG. 1.

FIG. 14 is a flowchart illustrating a relative route correcting process according to the second embodiment. The flowchart corresponds to the flowchart in FIG. 2A in the first embodiment.

First, at step S110 in FIG. 14, the absolute position acquiring section 10 starts execution of periodic absolute position acquisition. In the example illustrated in the drawing, the periodic absolute position acquisition is to acquire an absolute position, for example, at time intervals of three minutes or one minute. Then, at S112 and S114, the process and judgment are executed in substantially the same manners as those at S12 and S14 in the first embodiment. Then, at a time point that the judgment at S114 has been affirmed, that is, the traveling direction has been changed at the point B illustrated in FIG. 15, the process proceeds to S116.

At S116, the absolute position acquiring section 10 temporarily terminates execution of the periodic absolute position acquisition. In the above mentioned case, it is assumed that the absolute positions have been acquired at n points of a0, a1, a2, . . . a(n−1) while the user (the mobile phone) is moving from the point A to the point B as illustrated in FIG. 15.

Then, at S118, the azimuth calculating section 16 calculates an approximate straight line 1 from the plurality of absolute positions so acquired. In the above mentioned case, the approximate straight line 1 may be obtained by using a least square method. Prior to use of the least square method, it may be desirous to transform the coordinate system of the absolute positions a0 to a (n−1) to the coordinate system for the relative coordinates. In the above mentioned case, if the coordinates (the coordinates obtained after transforming to that for the relative coordinate system) of the absolute positions are expressed in the form of (x0, y0), (x1, y1), . . . (xn−1, yn−1), the gradient k and the intercept m used for calculation of the approximate straight line y (=kx+m) may be calculated by the following equations (3) and (4).

$$\begin{matrix}[ Numerical Formula 2 ] & \\ k = \frac{n {\sum }_{i = 0}^{n - 1} {x}_{i} {y}_{i} - {\sum }_{i = 0}^{n - 1} {x}_{i} {\sum }_{i = 0}^{n - 1} {y}_{i}}{n {\sum }_{i = 0}^{n - 1} {x}_{i}^{2} - {( {\sum }_{i = 0}^{n - 1} {x}_{i} )}^{2}} & ( 3 ) \\ [ Numerical Formula 3 ] & \\ m = \frac{{\sum }_{i = 0}^{n - 1} {x}_{i}^{2} {\sum }_{i = 0}^{n - 1} {y}_{i} - {\sum }_{i = 0}^{n - 1} {x}_{i} {y}_{i} {\sum }_{i = 0}^{n - 1} {x}_{i}}{n {\sum }_{i = 0}^{n - 1} {x}_{i}^{2} - {( {\sum }_{i = 0}^{n - 1} {x}_{i} )}^{2}} & ( 4 )\end{matrix}$$

Then, at S120, the absolute position acquiring section 10 starts again execution of the periodic absolute position acquisition. Then, the process and judgment at S122 and S124 are executed in substantially the same manners as those at S112 and S114. Then, at a time point that the judgment at S124 has been affirmed, that is, the traveling direction has been changed at the point C illustrated in FIG. 15, the process proceeds to S126.

At S126, the absolute position acquiring section 10 temporarily terminates execution of the periodic absolute position acquisition. Then, at S128, the azimuth calculating section 16 calculates an approximate straight line 2 from a plurality of absolute positions obtained while the user (the mobile phone) is moving from the point B to the point C. In the above mentioned case, the approximate straight line 2 is obtained from the above equations (3) and (4).

At S130, the azimuth calculating section 16 calculates an angle α (a direction change angle) defined by the approximate lines 1 and 2. In the above mentioned case, first, an intersection of these two straight lines is obtained. For example, assuming that the approximate straight line 1 is set to be e1Xx+f1Xy+g1=0 and the approximate straight line 2 is set to be e2Xx+f2Xy+g2=0, the intersection (xc, yc) will be obtained by the following equations (5) and (6).

xc=(f1·g2−f2·g1)/(e1·f2−e2·f1) (5)

yc=(e2·g1−e1·g2)/(e1·f2−e2f1) (6)

Then, an arbitrary point on the approximate straight line 1 is obtained. For example, the x-coordinate of any one of the absolute coordinates used for calculation of the approximate straight line 1 using the equations (3) and (4) and the y-coordinate obtained by substituting the x-coordinate into the equations for the approximate straight line 1 are used as coordinates of the arbitrary point on the approximate straight line 1. Likewise, an arbitrary point on the approximate straight line 2 is obtained in substantially the same manner as the above. That is, for example, the x-coordinate of any one of the absolute coordinates used for calculation of the approximate straight line 2 using the equations (3) and (4) and the y-coordinate obtained by substituting the x-coordinate into the equations for the approximate straight line 2 are used as coordinates of the arbitrary point on the approximate straight line 2.

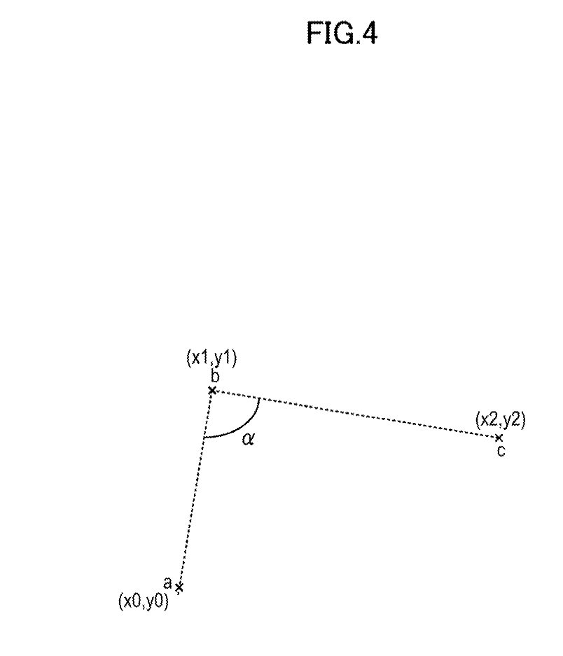

Then, the direction change angle α is calculated in substantially the same manner as those in FIG. 4 and the equation (1) using the coordinates of these three points.

Then, at S132, the moving route acquiring section 18 corrects the relative route using the direction change angle α. At S134, the azimuth calculating section 16 replaces the approximate straight line 2 with the approximate straight line 1. Then, at S136, the moving distance acquiring section 14 judges whether walking has been completed. In the case that judgment executed at 136 has been denied, the process returns to S120 and substantially the same processes as the above are repeatedly executed. On the other hand, in the case that the judgment executed at S136 has been affirmed, the processes illustrated in FIG. 2B are executed as in the case in the first embodiment to acquire the moving route.

As described above, according to the second embodiment, the direction change detecting section 12 detects whether the traveling direction of the user (the mobile phone) has been changed on the basis of the result of acquisition executed using the azimuth acquiring section 8, the absolute position acquiring section 10 acquires the plurality of absolute positions of the mobile phone at the timing (in the example, a consecutive time period until the traveling direction is changed) determined on the basis of the information as to whether the traveling direction has been changed, and, then, the moving route acquiring section 18 specifies the moving route of the mobile phone 100 from the approximate straight line obtained from the plurality of absolute positions and the moving distance. Therefore, even if the measurement error is present in the output from earth magnetism sensor 30 influenced by the leakage magnetic field, the angle α at which the traveling direction is changed will be obtained by using the absolute positions acquired at the direction change timing obtained from the result of detection executed using the earth magnetism sensor 30. Accordingly, highly accurate specification of the moving route may become possible by specifying the moving route by using the direction change angle α. In the above mentioned case, highly accurate specification of the moving route may become possible by specifying the moving route by using the direction change angle α. That is, the value indicative of the azimuth changing degree (the turning angle) which is output from the earth magnetism sensor 30 is not utilized in the specification of the moving route and hence a reduction in measurement accuracy influenced by the measurement error in the output from the earth magnetic sensor 30 may be avoided. In addition, according to the second embodiment, because the GPS receiver may receive the signals from the GPS satellites at periodic intervals, power saving may be promoted.

Incidentally, in the second embodiment, since the absolute positions are acquired at time intervals of three minutes or one minute, it may sometimes occur that the number of the absolute positions acquired until the user reaches a corner is only one. A third embodiment which will be described hereinbelow has been conceived of in order to cope with the case in which the number of acquired absolute positions is just one.

### Third Embodiment

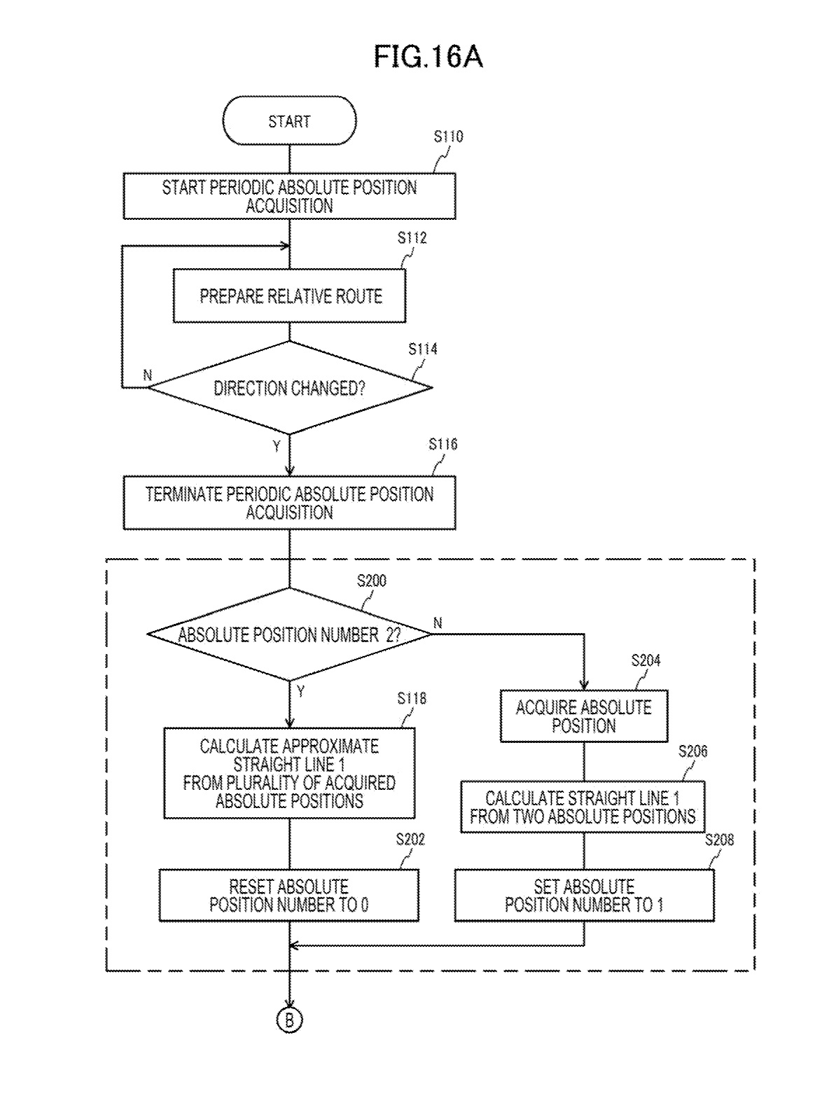

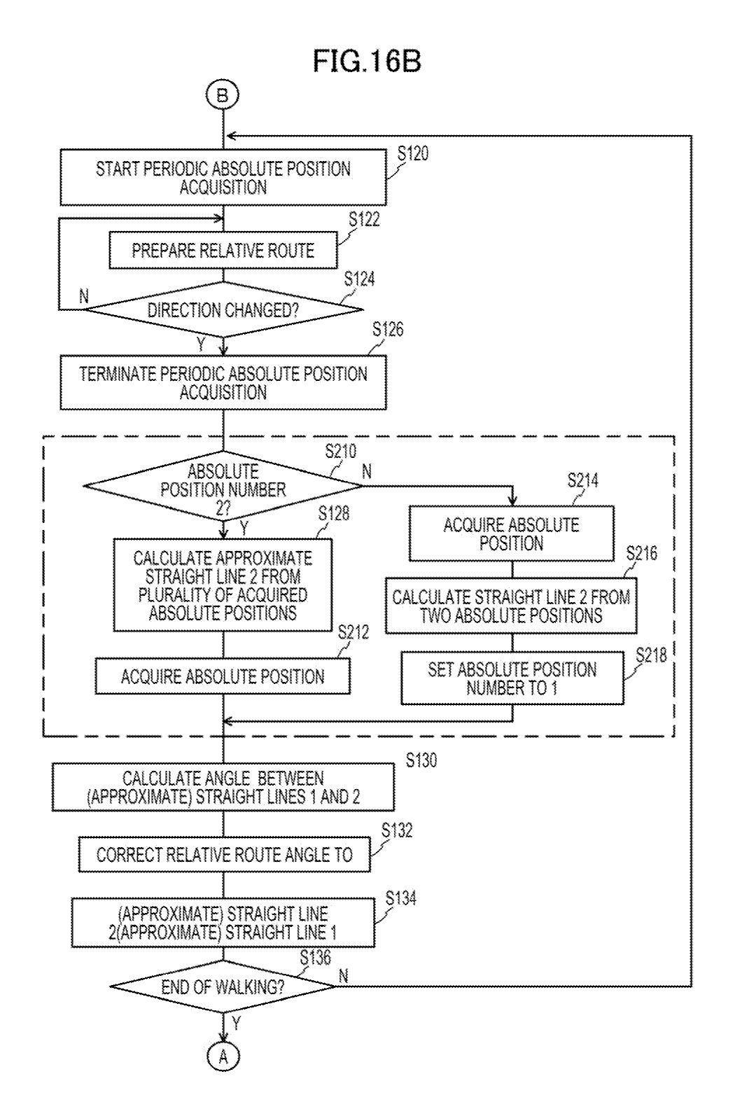

Next, a process of correcting a relative route of a mobile phone as a positioning device or having positioning capability according to the third embodiment will be described with reference to FIGS. 16A and 16B. Flowcharts illustrated in FIGS. 16A and 16B are obtained partially altering the flowchart in FIG. 14 which has been described in the explanation of the second embodiment. Accordingly, in the following, only altered processes (the processes surrounded by two-dot chain lines in FIGS. 16A and 16B) will be described in detail and description on processes commonly adopted in the second and third embodiments will be simplified or omitted. The same S-numbers are assigned to the common processes or operations.

First, processes at 5110 to S116 in FIG. 16A are executed to acquire the relative moving route extending from a start-walking position to a direction change position and to acquire one or more absolute position(s) and then the process proceeds to S200. At S200, the azimuth calculating section 16 judges whether the number of absolute positions acquired using the absolute position acquiring section 10 is two or more.

In the case that judgment has been affirmed at S200, calculation of the approximate straight line 1 is made possible as in the case in the second embodiment and hence a process of calculating the approximate straight line 1 at S118 is executed. Then, at S202, after the absolute position number has been reset to zero (0), the process proceeds to S120 in FIG. 16B.

On the other hand, in the case that the judgment at 200 has been denied, only the absolute position at the start-walking position is obtained and hence the absolute position at the direction change position is freshly acquired. Then, at S206, the straight line 1 is calculated using the absolute positions at the start-walking position and the direction change positions.

In this situation, assuming that the coordinates of two points are (xp, yp), (xq, yq), the gradient k and the intercept m used in the equation y=k+m for obtaining a straight line y running between two absolute positions will be calculated by the following equations (7) and (8).

k=(yq−yp)/(xq−xp) (7)

m=yp−{(yq−yp)/(xq−xp)}Xxp (8)

At S208, the azimuth calculating section 16 sets the absolute position number to one (1) and then the process proceeds to S120 in FIG. 16B. Incidentally, the reason why the absolute position number is set to one at S208 lies in that the absolute position acquired at the direction change position may be used both in calculation of the straight line 1 and calculation of the next straight line 2 (the approximate straight line 2). That is, in the case that the process has proceeded to succeeding operations via S208, one more absolute value may be acquired in order to calculate the approximate straight line 2.

Then, the processes at S120 to S126 in FIG. 16B are executed to acquire the relative moving route ranging from the preceding direction change position to the next direction change position and to acquire one or more absolute position(s). Then, the process proceeds to S210.

At S210, the azimuth calculating section 16 judges whether the number of absolute positions acquired using the absolute position acquiring section 10 is two or more. Then, in the case that judgment has been affirmed, the approximate straight line 2 is calculated using two or more absolute positions. Then, the absolute position number is reset to zero (0) at S212 and then the process proceeds to S130.

On the other hand, in the case that the judgment has been denied at S210, an absolute position at the direction change position is freshly acquired at S214 and the straight line 2 is calculated using two absolute positions and the above equations (7) and (8) at S216. Then, at S218, the absolute position number is set to one (1) and the process proceeds to S130.

At S130, the azimuth calculating section 16 calculates the angle α at which the traveling direction is changed using the straight lines 1 (or the approximate straight line 1) and 2 (or the approximate straight line 2) in substantially the same manner as that in FIG. 15. At S132, the moving route acquiring section 18 corrects the relative route using the direction change angle α and at S134, the azimuth calculating section 16 replaces the straight line 2 (the approximate straight line 2) with the straight line 1 (the approximate straight line 1). Then, at S136, the moving distance acquiring section 14 judges whether walking has been completed. In the case that judgment at S136 has been denied, the process returns to S120 and the above processes are repeatedly executed. On the other hand, in the case that the judgment at S136 has been affirmed, the processes in FIG. 2B are executed as in the case in the first embodiment to acquire the moving route.

Incidentally, in the case that the acquiring timing has been delayed as illustrated in FIG. 9A upon acquisition of the absolute positions executed at S204 in FIG. 16A and S214 in FIG. 16B, the absolute position may be corrected in substantially the same manner as that in the altered example of the first embodiment.

As described above, according to the third embodiment, substantially the same operational effect as that in the second embodiment may be obtained and even in the case that only one absolute position could be obtained for a time period from when the user started walking to when the traveling direction was changed or a time period between one direction change and another direction change, calculation of the direction change angle α and specification of the moving route may be executed highly accurately with no problem. In the above mentioned case, the moving route may be specified highly accurately by specifying the moving route using the direction change angle α. That is, the value indicative of the azimuth changing degree (the turning angle) which is output from the earth magnetism sensor 30 is not utilized in the specification of the moving route and hence the reduction in measurement accuracy influenced by the measurement error in the output from the earth magnetism sensor 30 may be avoided.

Incidentally, in each of the above mentioned embodiments, the case (real time correction) in which the moving route is corrected using the direction change angle α every time the user (the mobile phone) changes the traveling direction has been described. However, the embodiment is not limited to the above. For example, the moving route and the direction change angle may be acquired on demand and the moving route may be corrected later. The real time correction of the moving route may be also utilized as a safety service in ITS (Intelligent Transport Systems). For example, such a configuration may be possible that whether a user and a vehicle will come closer to each other at a corner is judged from the position of the user (a walker) who carries a mobile phone and the position (acquired from a navigation system installed in the vehicle) of the vehicle and when it has been judged that the user and the vehicle will come closer to each other, a safety notice is sent to the user (the walker) to warn the user that care should be taken. In addition, such a configuration may be also possible that advertisements of stores around a spot where the user is currently present are displayed on his mobile phone. In the case that a system of correcting the moving route later is adopted, such a configuration may be possible that the walking history of a user concerned is displayed on a map such that the user can confirm it or the walking history of a salesman concerned is provided to his superior official as a material to judge whether the salesman has called on his customers along a set route.

In the above mentioned embodiments and examples thereof, the moving route specifying device 50 may be configured by combining together a plurality of devices (corresponding to the respective sections in FIG. 1) or each device may be configured by a computer system in which a CPU (Central Processing Unit), a ROM (Read Only Memory) and a RAM (Random Access Memory) are combined with one another such that the function of each section is implemented by a program built into the computer system.

In each of the above mentioned embodiments, the description has been made on the case in which the positioning device is a mobile phone. However, the positioning device is not limited to the mobile phone and may be a car navigation system installed in a vehicle. In the latter case, the moving route acquiring section 14 may acquire the moving distance of the vehicle, for example, from the outer peripheral length of each tire of the vehicle and the number of revolutions of the tire.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Although the embodiments of the present inventions have been described in detail, it should be understood that the various changes, substitutions, and alterations could be made hereto without departing from the spirit and scope of the invention.

What is claimed is:

1. A positioning device comprising:
a device body;
a direction change detecting section that detects whether a traveling direction of the device body has been changed based on a detection of an azimuth with respect to reference axes preset in the device body; and
an absolute position acquiring section that acquires an absolute position of the device body at a timing based on a change of the moving direction of the device body as detected by the direction change detecting section.

2. The positioning device according to claim 1, further comprising:
an azimuth acquiring section that provides the detection of the azimuth with respect to the reference axes present in the device body.

3. The position device according to claim 1, further comprising:
a moving distance acquiring section that acquires a moving distance of the device body; and
a moving route acquiring section that specifies a moving route of the device body from the position of the device body acquired using the position acquiring section and the moving distance of the device body acquired using the moving distance acquiring section.

4. A positioning device comprising:
a device body;
an azimuth acquiring section that acquires an azimuth based on reference axes preset in the device body;
a moving distance acquiring section that acquires a moving distance of the device main body;
a direction change detecting section that detects whether a moving direction of the device body has been changed on the basis of a result of acquisition executed using the azimuth acquiring section;
an absolute position acquiring section that acquires absolute position information of the device body at a timing determined on the basis of whether the moving direction of the device body has been changed; and
a moving route acquiring section that specifies a moving route of the device body from the absolute position information of the device body acquired using the absolute position acquiring section and the moving distance of the device body acquired using the moving distance acquiring section.

5. The positioning device according to claim 4, wherein
the absolute position acquiring section acquires the absolute position information of the device body at a timing that the device body has changed its moving direction.

6. The positioning device according to claim 5, further comprising:
an azimuth calculating section that calculates an angle at which the moving direction has been changed using the absolute position information acquired at the timing that the device body has changed its moving direction; and
wherein the moving route acquiring section specifies the moving route of the device body from the angle at which the moving direction has been changed and the moving distance of the device body.

7. The positioning device according to claim 6, wherein
the moving route acquiring section detects a positional error between a position where the traveling direction change detected using the direction change detecting section and a position where the absolute position of the device body has been acquired using the absolute position acquiring section, and further specifies the moving route of the device body using the detected positional error.

8. The positioning device according to claim 6, wherein
the absolute position acquiring section acquires the absolute position of the device body a plurality of times within a consecutive time period before the moving direction is changed and within a consecutive time period after the traveling direction has been changed,
the azimuth calculating section calculates the angle at which the moving direction has been changed from a first line determined from the plurality of absolute positions acquired before the traveling direction is changed and a second line determined from the plurality of absolute positions acquired after the traveling direction has been changed, and
the moving route acquiring section specifies the moving route of the device body from the angle at which the moving direction has been changed and the moving distance of the device body.

9. A computer-readable medium for recording a program allowing a computer to execute:
acquiring an azimuth based on reference axes preset in a device body;
acquiring a moving distance of the device body;
detecting whether a moving direction of the device body has been changed on the basis of a result of the acquiring the azimuth;
acquiring absolute position information of the device body at a timing determined on the basis of information as to whether the moving direction of the device body has been changed from the detecting; and
specifying a moving route of the device body from the acquired absolute position information of the device body and the acquired moving distance of the device body.
